(19) United States
(12) Patent Application Publication
(10) Pub. No.: US 2012/0310604 A1
(43) Pub. Date: Dec. 6, 2012

(54) THREE-DIMENSIONAL GEOMETRIC DESIGN, ANALYSIS, AND OPTIMIZATION OF SHELL STRUCTURES

(76) Inventors: Yuri Bazilevs, La Jolla, CA (US); Ming-Chen Hsu, La Jolla, CA (US); Kai-Uwe Bletzinger, Feldafing (DE); Michael Breitenberger, Ulten (IT); Roland Wuechner, Munich (DE); Josef Kiendl, Pavia (IT); Robert Schmidt, Osterhofen (DE)

(21) Appl. No.: 13/441,666

(22) Filed: Apr. 6, 2012

Related U.S. Application Data
(60) Provisional application No. 61/473,685, filed on Apr. 8, 2011.

(51) Int. Cl. G06F 17/50

(52) U.S. Cl. 703/1

(57) ABSTRACT

In some implementations, there may be provide a method for modeling and simulation. The method may include generating a model of an object, wherein the model defines at least a surface of the object, wherein the surface comprises a plurality of patches generated based on a function (e.g., a spline, a T-spline, a non-uniform rational B-spline, and the like); presenting, at a user interface, the surface of the object in accordance with the model; inserting into the model of the object a bending strip between a first patch on the surface and a second patch on the surface; performing an analysis of the model including the bending strip, the first patch, and the second patch; and presenting, at the user interface, a three-dimensional representation of the object including a result of the analysis. Related system, apparatus, and articles of manufacture are also disclosed.

### CROSS-REFERENCE TO RELATED APPLICATIONS

This application claims the benefit of U.S. provisional patent application Ser. No. 61/473,685, filed on Apr. 8, 2011 and entitled “A Fully Integrated Methodology and Framework for 3D Geometric Design, Analysis and Optimization of Blade Structures for Turbine-Based Energy Extraction Devices,” which is incorporated by reference herein in its entirety.

### FIELD

The subject matter described herein relates to three-dimensional models for representing structures, such as blades.

### BACKGROUND

Computer-aided design (CAD) refers to using a computer to design an object. For example, a computer-aided design system may provide tools that allow a user to design the object. To enable the design process, the computer-aided design system may include a numerical representation of the object, and this numerical representation may facilitate generating visual representations for display to a designer. For example, the numerical representation may consist of vector data configured to geometrically model and visualize the object. The computer-aided design system may also generate an output to allow simulation, analysis, manufacture, and the like of the object.

A simulation and analysis system may also be used during the design of an object. However, the numerical representation of the object may primarily facilitate the simulation and analysis, rather than viewing the object. For example, the simulation and analysis of the object may simulate and analyze the impact of loads on the object and then generate an output to allow further computer-aided design, analysis, manufacture, and the like of the object. A computer-aided design system may provide a data file of an object to a simulation system, which converts the data file into a format suitable for the simulation and analysis. Once the simulation and analysis of the object is complete, the simulation and design system may provide another data file to the computer-aided design system, and this other data file may be converted into a visually oriented format before use by the computer-aided design system.

### SUMMARY

The subject matter disclosed herein provides methods, apparatus, and articles of manufacture for a model configured to facilitate computer-aided design and analysis of a structure, such as the structure of a blade.

In some implementations, there may be provide a method. The method may include generating a model of an object, wherein the model defines at least a surface of the object, wherein the surface comprises a plurality of patches generated based on a function; presenting, at a user interface, the surface of the object in accordance with the model; inserting into the model of the object a bending strip between a first patch on the surface and a second patch on the surface; performing an analysis of the model including the bending strip, the first patch, and the second patch; and presenting, at the user interface, a three-dimensional representation of the object including a result of the analysis. Related system, apparatus, and articles of manufacture are also disclosed.

The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system in accordance with some exemplary implementations;

FIG. 2 depicts an example of a process in accordance with some exemplary implementations;

FIG. 3 depicts an example of two patches and a bending strip in accordance with some exemplary implementations;

FIG. 4 depicts an example of a surface of a blade structure in accordance with some exemplary implementations;

FIG. 5 depicts examples of shear webs (e.g., rectangular surfaces connecting the upper and lower sides of the blade) in accordance with some exemplary implementations;

FIG. 6 depicts example results of the structural analysis calculations performed directly on the computer-aided design representation of the blade in accordance with some exemplary implementations;

FIG. 7 depicts an example set of analysis results in accordance with some exemplary implementations; and

FIGS. 8-10 depict example implementations of bending strips used in connection with various structures.

### DETAILED DESCRIPTION

In some exemplary embodiments, the subject matter described herein may provide a functional representation (also referred to herein as a model) of an object, such as a structure. This functional representation may be used during the three-dimensional (3D) geometric design of the structure and during the simulation and/or analysis of the structure.

In some exemplary implementations, the structure may comprise a blade for use in turbine-based energy extraction devices, such as wind turbines or hydro turbines. Although some of the examples described herein refer to blade structures, other types of objects and structures may be used as well.

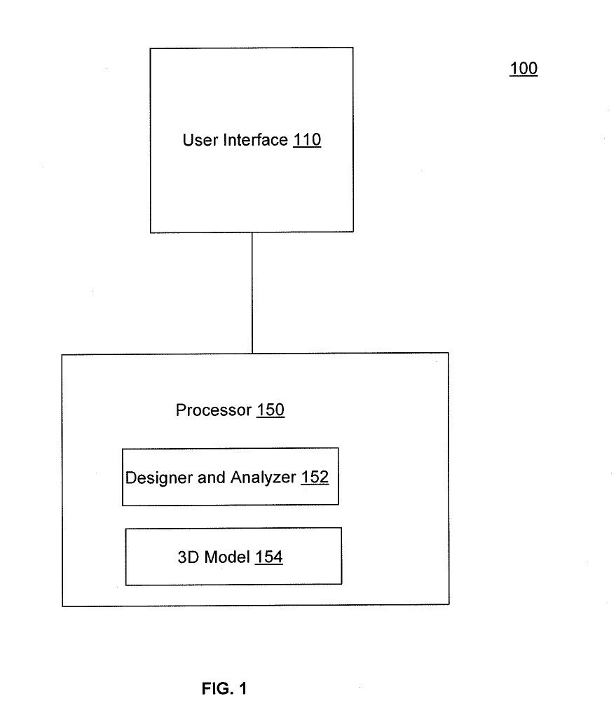

FIG. 1 depicts a system 100 including a user interface 110 and a processor 150. The user interface 110 may be implemented as a browser, a thin-client, and/or any other application enabling a user, such as a designer, to access, view, and/or otherwise interact with processor 150.

The processor 150 may be implemented as a computer and may include memory. The processor 150 may further include a designer and analyzer 152 configured to provide, based on a functional representation (e.g., a model) of a structure, three-dimensional (3D) geometric design, simulation, analysis, and/or optimization of the structure, such as a blade. Moreover, the same functional representation of the structure may be implemented during the geometric design, simulation/analysis, and optimization of the structure. In the example of FIG. 1, the functional representation of the structure is depicted as model 154.

The designer and analyzer 152 may be configured to provide the model 154 of the structure, such as a blade, and the model 154 may be used in the visually-oriented computer-aided design of the structure and then used later during the more mathematically-oriented simulation and analysis of the structure. The model 154 may be implemented based on isogeometric analysis (IGA), which may be further configured to implement a non-uniform rational B-splines (NURBS), although other types of functions may be used as well. Examples of these other functions may include other splines, such as T-splines. In some exemplary embodiments, the model 154 of the structure may also be implement based on so-called “bending” strips as described further below.

Isogeometric analysis takes advantage of the underlying smoothness (e.g., the higher-order differentiability) of the basis functions, such as NURBS and the like, for computer-aided design representation. This may, in some implementations, be beneficial for the analysis of thin structures, such as shells, that are typically used in the design and manufacturing of blades and other structures. Moreover, the isogeometric analysis of blades may, in some implementations, allow for more accurate and efficient numerical formulations for shell-type structures, when compared to other approaches, such as finite element methodologies. The isogeometric analysis based on NURBS may, in some implementations, allow one geometric description to be employed throughout the design-to-analysis process.

In some implementations, system 100 may be used to design and simulate/analyze the blade. The model 154 may configured as a three-dimensional model to allow a designer to design the geometry of the blade including the outer surface of the blade and structural reinforcement elements, such as spar caps, shear webs, and other support and/or stiffening structures. Shear webs represent rectangular surfaces connecting the upper and lower surfaces of the blade. For example, a shear webs may correspond to an I-beam like structure that connects the pressure and suction surfaces of the blade. The shear webs may also provide flap-wise bending stiffness (e.g., bending stiffness in the direction of the fluid flow of the blade) and torsional stiffness. Spar caps run along the blade surface in the axial direction and add edge-wise bending stiffness (e.g., bending in the plane of rotation).

NURBS may be configured to provide so-called “patches,” which serve as individual portions of the surface of the blade, and these NURBS patches are joined to form the outer surface of the blade. When the patches are joined to form the outer surface, the designer and analyzer 152 maintains geometric continuity, which provides rules to avoid gaps or overlaps in the surface geometry of the blade.

Although the description herein refers to model 154 using examples related to a structure of a blade (“blade structure”) of a wind turbine, other structures (e.g., aircraft wings, drone wings, helicopter blades, and the like) may designed, analyzed, and the like using system 100.

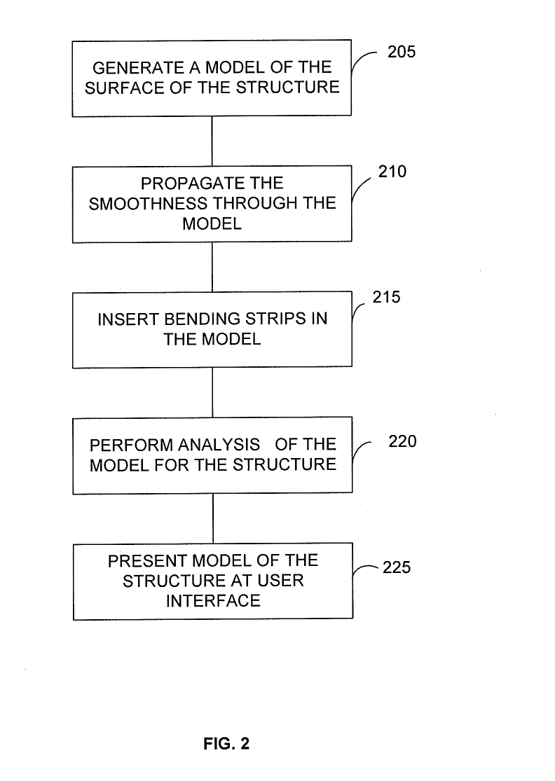

FIG. 2 depicts an example of a process 200, which may be implemented by system 100.

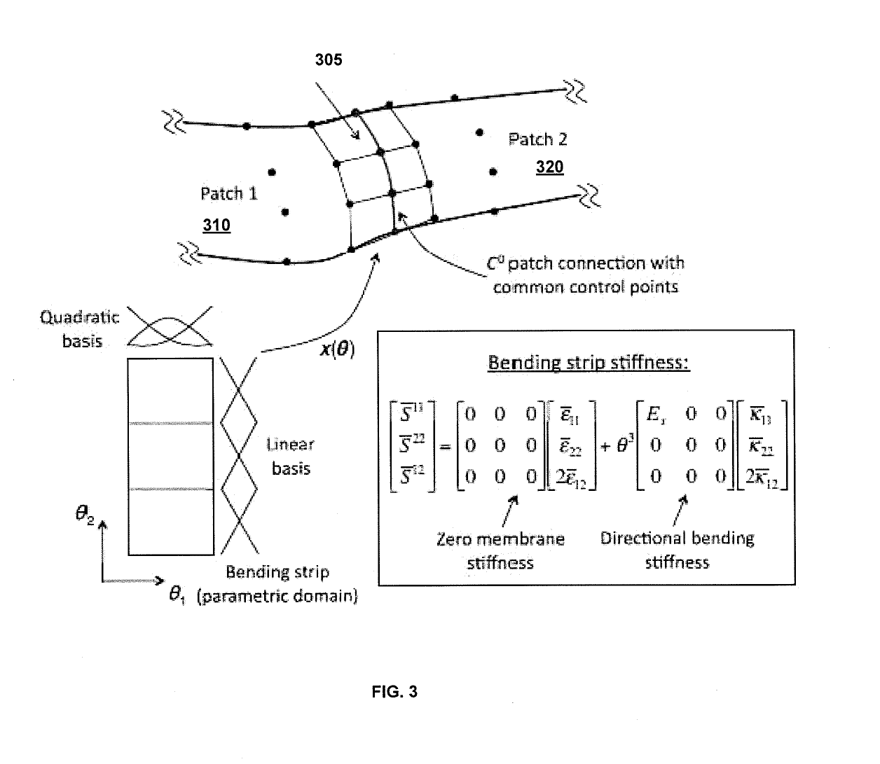

At 205, designer and analyzer 152 may generate a surface. To generate a surface, designer and analyzer 152 may perform a structural analysis of the structure based on NURBS. The surface may be formed as a plurality of patches, and the patches may be formed based on NURBS. FIG. 3 depicts an example of patches (also referred to as NURBS patches) 310 and 320 forming a portion of the surface of the blade. Moreover, designer and analyzer 152 may include rules to enforce geometric continuity, so that there are no gaps between the patches forming the surface of the blade. The generated surface comprises the model 154 of the blade in three dimensions. Once the three-dimensional model 154 is created, material properties may be assigned and/or defined to individual patches, and loading conditions for the type of structural analysis to be performed may be defined for each of the patches. During the surface generation at 205, the user interface 110 may be used to present a view of the surface of the blade based on model 154. The material properties specified may include one or more of the following: a thickness, a quantity of composite plies (which may include materials, such as fiberglass, carbon fiber, balsa wood, and the like), and a fiber orientation for each ply. The loading conditions specified may include one or more of the following: gravitational loads, centripetal loads, and/or aerodynamic/hydrodynamic loads acting on the blade structure.

The designer and analyzer 152 may process the surface model and allow insertion of structural reinforcement elements. At 210, when the shear webs are inserted, the shear webs may create lines of derivative discontinuities in the insertion locations. In order for the geometry description to be analysis-suitable, the designer and analyzer 152 may propagate these lines of derivative discontinuity to the ends on the blade surface.

At 215, designer and analyzer 152 may programmatically insert bending strips between patch boundaries. For the treatment of patch boundaries, the bending strips (which are further described below) represent a virtual (also referred to as fictitious) material with substantially unidirectional bending stiffness and substantially zero mass and membrane stiffness at the patch boundaries (e.g., the interface between two patches). The direction of bending stiffness may be chosen to be transverse to the patch interface.

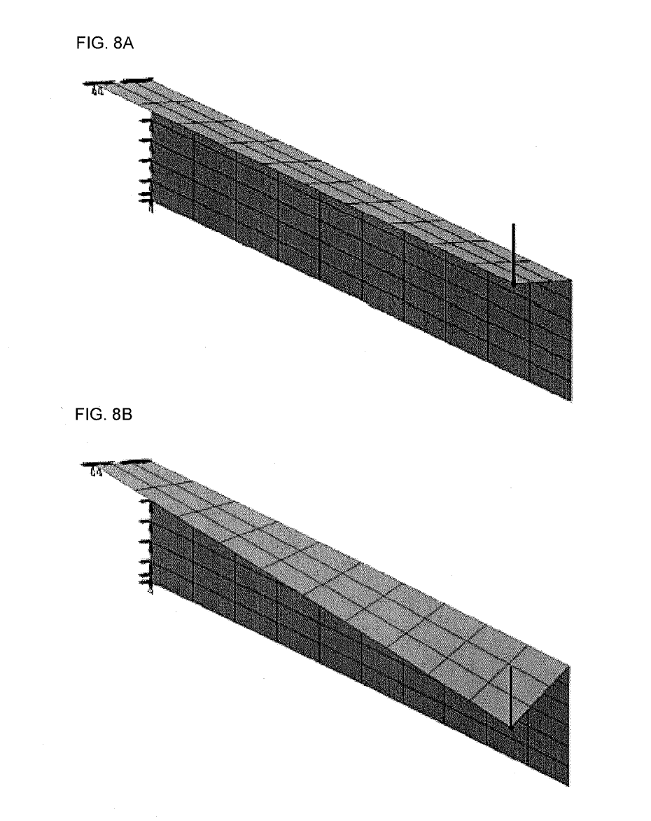

FIGS. 8-10 described further below illustrate how the bending strip is used in the case of a bracket. The bending strip connects the two patches forming the bracket. It is defined such that the bending strip is stiff only in the direction orthogonal to the line that defines the interface between the two patches that form the bracket. As a result, when a point load is applied at the corner of the top patch, the bending moment is correctly transferred to the bottom patch, and the bracket attains a correct deformed shape. If the bending strip is not present, the response to the point load may be incorrect as depicted in FIG. 8B.

FIG. 3 depicts an example of a bending strip 305 placed on the first patch 310 and the second patch 320. It is given that before the bending strip is placed, the two surface patches are merged with parametric continuity. This represents that for the same value of the parameter the corresponding physical locations on the two edges are the same, or similar. Parametric continuity may also represent that a physical property of the first patch 310 may be represented as a parametric value that continuously extends to the second patch 320. This parametric continuity rule may be considered necessary for the structural blade model creation. However, the requirement that parametric derivatives of the surface match along the common edge may not be necessary, when the surface geometry is being generated/created. This relation of the matching condition may facilitate geometry creation. However, when the structure is analyzed using the Kirchhoff-Love shell theory, the parametric derivative continuity of the structural displacement field may be considered again. By placing the bending strip 305 with the stiffness and mass requirements discussed above, the structural displacement derivative continuity is enforced approximately as a part of the Kirchhoff-Love shell analysis procedure. During the insertion of the bending strip at 215, the user interface 110 may present, based on model 154, a view of the blade including the patches 310-320 and bending strips.

Referring again to FIG. 2, designer and analyzer 152 may then perform a simulation and analysis, at 220, of the model of the structure, such as the blade. For example, the analysis may include a Kirchhoff-Love shell analysis, although other types of analysis may be performed as well. This analysis may provide structural displacement and stress distributions under the action of user-specified loads. An example of the Kirchhoff-Love shell analysis based on bending strips is further described below.

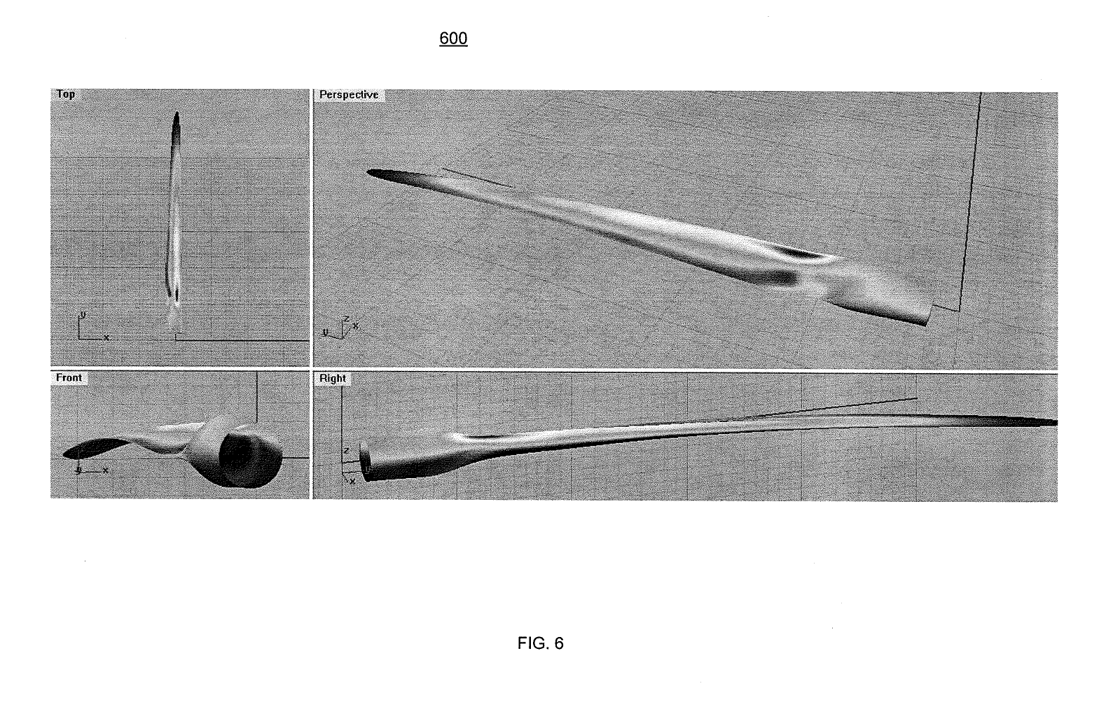

Because the same model 154 is used during process 200, the user interface 110 may be used to present, based on model 154, a three-dimensional view of the blade during the design stages (e.g., 205, 225, and the like) and during the simulation and analysis stage at 220. And, the results of the simulation and analysis may be presented at user interface 110 as well. FIG. 6 described further below depicts the blade including the simulation and analysis results, which may correspond to stresses on the blade as depicted by different color/shades.

At 225, user interface 110 may present the model 154 to allow a designer to further geometrically design and visualize the structure of, for example, the blade. The designer and analyzer 152 may generate the visualization based on model 154 and provide the generated visualization for presentation at user interface 110. Based on the results of the analysis 220 and/or the presentation 225, a designer may initiate changes to the model 154 representative of the structure, such as the blade. Because the structural analysis and simulation makes use of the same functional representation, such as model 154, as the geometrical design, the output of analysis and simulation is in the format that can be used directly (e.g., with little, if any, conversions) by the system 100 to geometrically design the structure or blade, enabling the user-designer or user-analyst to review the results, make modifications to the design, and re-run the simulation and analysis.

In some implementations, system 100 may also provide the model 154 representative of the blade structure to another processor associated with manufacturing. As such, the same functional description, or model 154, may employed in the geometric design, simulation/analysis, and manufacturing.

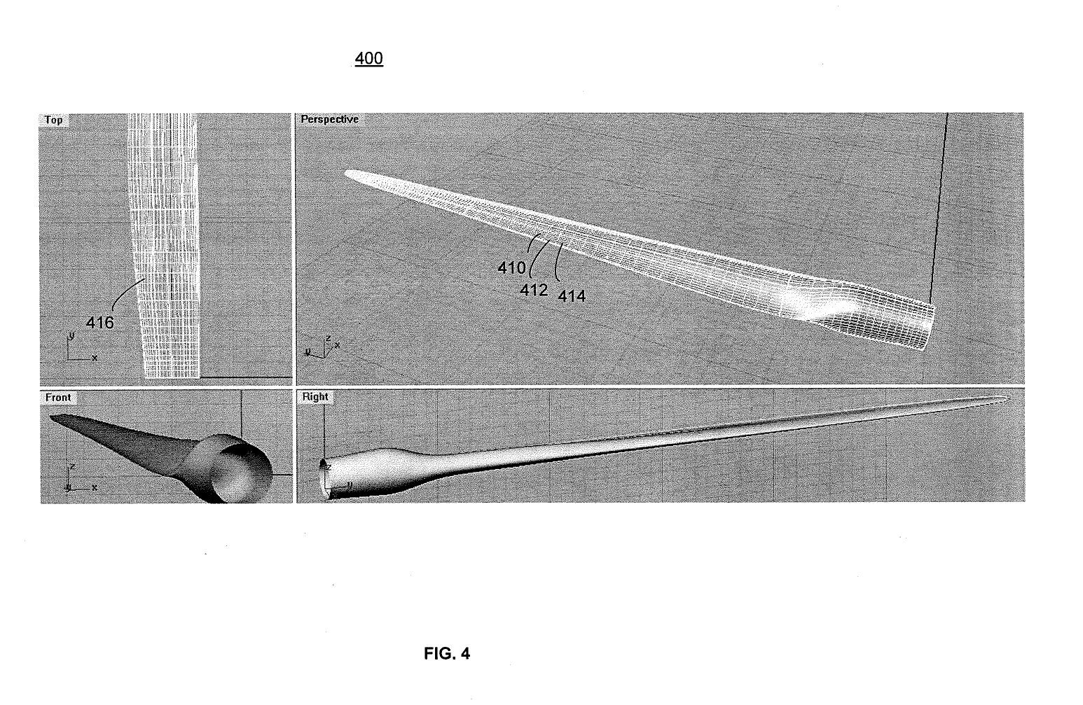

FIG. 4 depicts an example of a page 400 presenting a model of a surface of a wind turbine blade. System 100 may generate the model, such as model 154, using process 200. The blade geometry may be defined as a sequence of aerodynamically and/or hydrodynamically optimized airfoil cross-section shapes with prescribed twists that are smoothly blended together using NURBS surface technology to create the model 154 of a smooth structural surface in three dimensions as depicted at FIG. 4. The model 154 of the blade surface is comprised of multiple NURBS patches, such as patches 410-416 and the like.

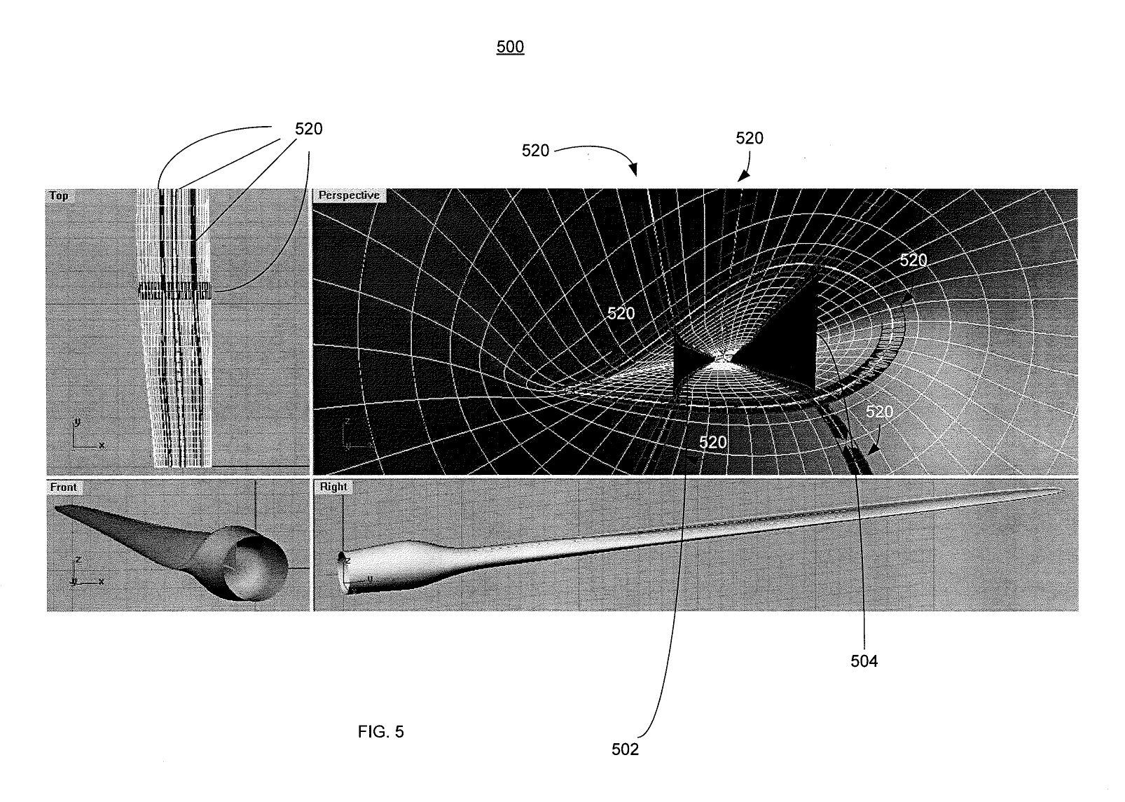

FIG. 5 depicts an example of a page 500 presenting a model, such as model 154, of a surface of a wind turbine blade. The model at page 500 is similar to page 400 but shows the addition of additional structural elements, such as shear webs 502 and 504. The model at page 500 also shows the addition of bending strips 520 created by system 100. The bending strips are implemented as NURBS used to transfer bending moments in the direction orthogonal to the NURBS patch boundaries. Throughout the blades design process 200, a designer at user interface 110 may add structural elements, such as the shear webs 502 and 504, and the bending strips 520 graphically via page 500 presented at user interface 110, and then designer and analyzer 152 may add the shear webs 502-504 and bending strips 520 to the model 154 of the blade structure. In some implementations, the designer and analyzer 152 may detect patch boundaries programmatically, and then programmatically insert the bending strip with little, or no, intervention by a user.

Although FIG. 5 depicts the addition of bending strips and shear webs, other structural aspects may be added to the page 500 and/or model 154 as well.

FIG. 6 depicts an example of the results of the structural analysis performed at 220, which is described with respect to FIG. 2. The analysis may be generated as a page 600 and displayed in, for example, user interface 110. In some implementations where system 100 corresponds to a computer-aided design system configured with NURBS, the same system (and user interface 110) may be used for both geometric design and the subsequent simulation and analysis of that design. The information presented at page 600 may be useful to a designer/analyst to make decisions regarding further design modifications of the blade structure.

The designer/analyst operating system 100 may also define parameters for the analysis at 220, such as the material properties of the surface and/or structure of the blade. Examples of parameters include: shell thickness defining the thickness of the outer surface of the blade, constitutive matrices for composite analysis, and the like. The parameters may be stored as part of model 154. Moreover, system 100 may also be provided with loads to be used during the analysis at 220 of the blade structure, and the load parameters may also be stored at model 154. The loads may include one or more of the following: user-defined point, user-defined distributed loads, gravity and centripetal loads, loads due to air or water flow, and the like. Some of the loads may be determined using computational fluid dynamics (CFD) computations and/or experimental data. In any case, the system 100 may analyze the model 154 of the blade structure given the NURBS, bending strips, parameters, and the like, and then generate an output as depicted at page 600.

Page 600 shows that the wind turbine blade designed in the system 100 was directly simulated and analyzed subject to parameters, such as centripetal and wind loads. The stress distribution (which is represented by the different shades) over the deformed blade structure configuration is displayed at user interface 110. As such, the same system 100 uses the same model 154 to design the blade structure, analyze the blade structure, and present the results of the analysis. The example shown at FIG. 6 makes use of non-linear static shell analysis under prescribed loading, although other types of analysis may be used as well including, for example, computation of natural frequencies and mode shapes to assess the structural vibration characteristics of the blade design, computation of a stress-free blade shape that deform into a design configuration when the blade is in operation, computation of structurally optimized shape to minimize a quantity of engineering interest, and the like.

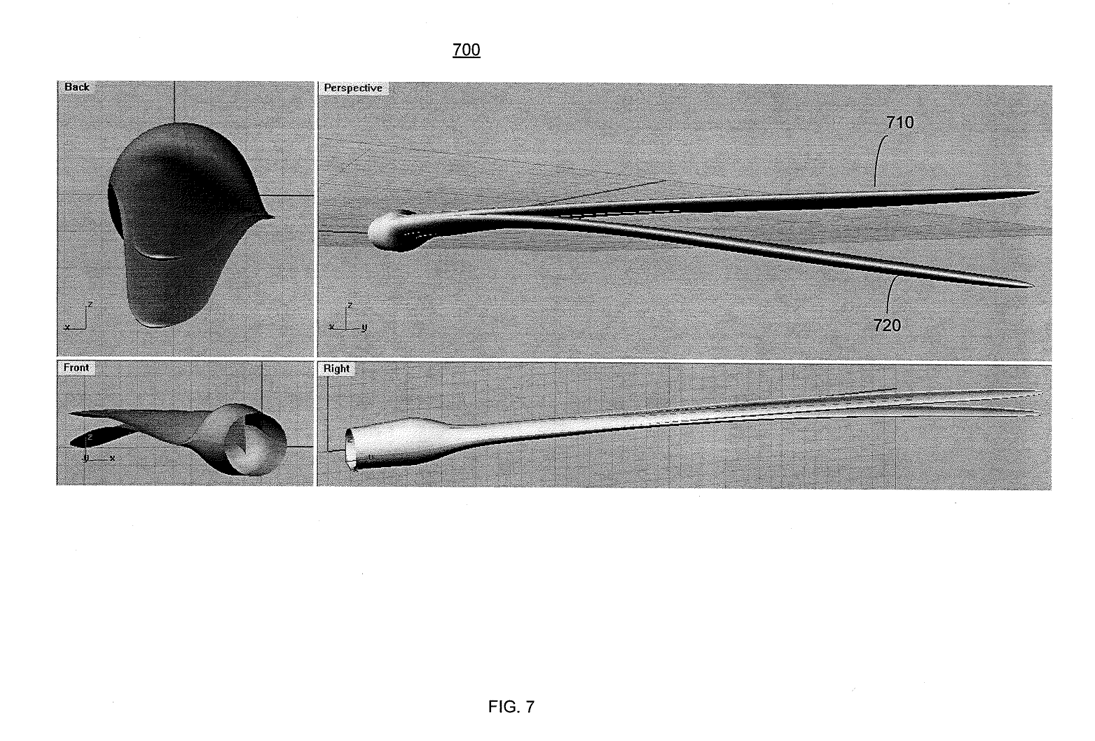

FIG. 7 depicts another page 700 generated by the simulation and analysis performed at 220 of FIG. 2. FIG. 7 depicts an example showing how the blade design was improved using the process 200 described herein. In the example of FIG. 7, the undeformed blade is depicted at 710, and the blade subjected to the deformation (or displacement) induced by a load, as determined by the simulation and analysis, is depicted at 720.

The following describes exemplary embodiments of system 100 configured to provide bending strips-based isogeometric analysis of shell structures in accordance with the Kirchhoff-Love shell theory.

The Kirchhoff-Love shell theory may assume that a cross-section normal to the middle surface of the shell remains normal to the middle surface during the deformation, which implies that transverse shear strains are negligible. The Kirchhoff-Love shell theory may be appropriate for thin shells (e.g., 20≦R/t, where R is the shell radius of curvature and t is its thickness). Thin shells may have an optimal load-carrying behavior and therefore allow the construction of highly efficient light-weight structures. In the governing mechanical variational equations of the Kirchhoff-Love theory, second order derivatives appear, and therefore a C¹-continuity of the approximation functions may be required for the discrete formulation to be conforming. Furthermore, NURBS basis functions may have the necessary smoothness at the patch level. In addition, NURBS may be considered inherently higher order, which also alleviates locking associated with lower order shell discretizations. And, the Kirchhoff-Love theory formulation may be displacement based and may not require rotational degrees of freedom.

The designer and analyzer 152 may be configured to implement rotation-free isogeometric shell analysis using NURBS including adding bending strips (also referred to herein as strips) of material in places where the NURBS patches are joined with C⁰-continuity. The bending strips may have bending stiffness only in the direction transverse to the patch intersection, and no membrane stiffness. The bending strips may be generated automatically by designer and analyzer 152.

The bending strips may overlap one row of control points on each side of the patch intersection and prevent the structure from developing unphysical deformations (e.g., kinks) at the location, which would occur otherwise. The bending strips may also be able to handle patches that are coupled with G¹-continuity as well as patches that meet at a kink (e.g., the trailing edge of an airfoil).

The following provides additional description of the Kirchhoff-Love shell theory. The variational formulation of a Kirchhoff-Love shell is based on the principle of virtual work expressed by the following equation:

δW=δWᵢₙₜ+δWₑₓₜ=0, (1)

where W, Wᵢₙₜ, and Wₑₓₜ denote the total, internal, and external work, respectively, and δ denotes a variation with respect to the virtual displacement variables Υu, that is

$$δ W = \frac{\partial W}{\partial u} δ u .. \qquad ( 2 )$$

The internal virtual work is defined by the following equation:

δWᵢₙₜ=−∫_{V}(S:δE)dV, (3)

where V is the shell volume in the reference configuration (e.g., the total Lagrangian), E is the Green-Lagrange strain tensor, δE is its variation with respect to virtual displacements δu, and S is the energetically conjugate second Piola-Kirchhoff stress tensor.

When designer and analyzer 152 is configured in accordance with Kirchoff-Love shell theory, the three-dimensional continuum description may be reduced to that of a shell midsurface, and the transverse normal stress may be neglected. Furthermore, the shell cross-sections may be treated as remaining normal to its middle surface in the deformed configuration, which implies that the transverse shear strains are zero. As a result, only in-plane stress and strain tensors are considered, and Greek indices, α=1, 2 and β=1, 2, are employed to denote their components. The components of the Green-Lagrange strain tensor are separated into two parts corresponding to membrane and bending action as follows:

E_{αβ}=ε_{αβ}+θ³κ_{αβ}; (4)

where θ³ε[−0.5t, 0.5t] is the through-thickness coordinate, t is the shell thickness, and ε_{αβ} are the membrane strains given by the following equation:

$${ɛ}_{α β} = \frac{1}{2} ( {g}_{α β} - {G}_{α β} ) , , \qquad ( 5 )$$

and κ_{αβ} are the changes in curvature as defined by the following equation:

κ_{αβ}=b_{αβ}−B_{αβ} (6).

In Equation (5) above, designer and analyzer 152 may configure the covariant metric tensors based on the following equations:

g_{αβ}=g_{α}·g_{β}=x,_{α}·x,_{β} (7), and

G_{αβ}=G_{α}·G_{β}=X,_{α}·X,_{β} (8),

and in Equation (6), the designer and analyzer 152 may define the curvature tensors based on the following equations:

b_{αβ}=−g_{α,β}·g₃ (9)

B_{αβ}=−G_{α,β}·G₃ (10),

where x and X are the position vectors of material points in the current and reference configuration, respectively, and (·),_{α} denotes partial differentiation with respect to curvilinear coordinates θα, which in this case coincide with the NURBS parametric coordinates.

In Equations (9)-(10), g₃ and G₃ are the unit vectors in the direction normal to the shell midsurface in the current and reference configurations, respectively.

In Equation (4), the components of the Green-Lagrange strain tensor are given with respect to the contravariant basis vectors G^{α} that are related to the covariant basis vectors G_{β} as follows:

G^{α}=[G_{αβ}]⁻¹G_{β}. (11)

Given the covariant basis of Equation (11), designer and analyzer 152 may define the local orthonormal basis ē_{α} by orienting it on G₁ as follows:

$$\begin{matrix}{\overline{e}}_{1} = \frac{{G}_{1}}{‖ {G}_{1} ‖} , & ( 12 ) \\ {\overline{e}}_{2} = \frac{{G}_{2} - ( {G}_{2} \cdot {\overline{e}}_{1} ) {\overline{e}}_{1}}{‖ {G}_{2} - ( {G}_{2} \cdot {\overline{e}}_{1} ) {\overline{e}}_{1} ‖} .. & ( 13 )\end{matrix}$$

Given the local basis of Equations (12)-(13), designer and analyzer 152 may employ the following linear orthotropic stress-strain relationship in the local coordinate system:

$$\begin{matrix}[ \begin{matrix}{\overline{S}}^{11} \\ {\overline{S}}^{22} \\ {\overline{S}}^{12}\end{matrix} ] = \overline{C} [ \begin{matrix}{\overline{E}}_{11} \\ {\overline{E}}_{22} \\ 2 {\overline{E}}_{12}\end{matrix} ] , \\ where & ( 14 ) \\ \overline{C} = [ \begin{matrix}\frac{{E}_{1}}{( 1 - {v}_{12} {v}_{21} )} & \frac{{v}_{21} {E}_{1}}{( 1 - {v}_{12} {v}_{21} )} & 0 \\ \frac{{v}_{12} {E}_{2}}{( 1 - {v}_{12} {v}_{21} )} & \frac{{E}_{2}}{( 1 - {v}_{12} {v}_{21} )} & 0 \\ 0 & 0 & {G}_{12}\end{matrix} ] , & ( 15 )\end{matrix}$$

and

where E₁ and E₂ are the Young's moduli in the directions defined by the local basis vectors, ν's are the Poisson ratios, G₁₂ is the shear modulus, and ν₂₁E₁=ν₁₂E₂ to ensure the symmetry of the constitutive material matrix C.

In the case of an isotropic material, E₁=E₂=E, ν₂₁=ν₁₂=ν, and G₁₂=E/(2(1+ν)). Using Equations (14) and (4) into the expression for the internal virtual work given by Equation (3), and pre-integrating through the shell thickness, the following is obtained:

$$δ {W}_{int} = - {\int }_{A} ( t {\overline{ɛ}}^{T} \overline{C} δ \overline{ɛ} + \frac{{t}^{3}}{12} {\overline{κ}}^{T} \overline{C} δ \overline{κ} ) d A , , \qquad ( 16 )$$

where ε and κ are the vectors of membrane strain and curvature tensor coefficients in Voigt notation (in the local coordinate system), and dA is a differential area of the shell midsurface.

To illustrate further, the following describes an example implemented by designer and analyzer 152. To obtain a conforming discretization of the Kirchhoff-Love variational shell theory, the underlying basis functions is typically C¹-continuous. This may be achieved using NURBS-based isogeometric analysis when one or more patch geometry representations are employed.

The designer and analyzer 152 may configure a NURBS surface for patch i, Sⁱ(θ₁, θ₂)ε [symbol] ^{d}, d=2, 3, parametrically as follows:

$${S}^{i} ( {θ}_{1} , {θ}_{2} ) = {\sum }_{a = 1}^{{n}_{1}} {\sum }_{b = 1}^{{n}_{2}} {P}_{a , b}^{i} {R}_{a , b}^{j} ( {θ}_{1} , {θ}_{2} ) , , \qquad ( 17 )$$

where θ₁ and θ₂ are the parametric coordinates that coincide with the shell midsurface convective coordinates, n¹ and n² are the number of univariate B-spline functions in the two parametric directions, P's are the control points, and R's are the NURBS basis functions given by the following equation:

$${R}_{a , b}^{j} ( {θ}_{1} , {θ}_{2} ) = \frac{{w}_{a , b}^{j} {N}_{a}^{i} ( {θ}_{1} ) {N}_{b}^{i} ( {θ}_{2} )}{{\sum }_{c = 1}^{{n}_{1}} {\sum }_{d = 1}^{{n}_{2}} {w}_{c , d}^{i} {N}_{c}^{i} ( {θ}_{1} ) {N}_{d}^{i} ( {θ}_{2} )} .. \qquad ( 18 )$$

In Equation (18), values of the w's are non-negative scalar weights and N's are the univariate B-spline basis functions.

The parametric space may be sub-divided by the designer and analyzer 152 into elements by so-called “knots.” NURBS basis functions may be considered C^{∞}-continuous on the element interiors and C^{p-k}-continuous at the element boundaries, where p is the polynomial order and k is the knot multiplicity of the univariate B-splines. As a result, quadratic or higher-order NURBS are typically necessary for Kirchhoff-Love shell analysis. The designer and analyzer 152 may make the Kirchhoff-Love shell equations discrete using Galerkin's method. The shell displacements for patch i are expanded in terms of the same NURBS basis functions used for the definition of the shell midsurface geometry based on the following equation:

$${u}^{i} ( {θ}_{1} , {θ}_{2} ) = {\sum }_{a = 1}^{{n}_{1}} {\sum }_{b = 1}^{n - 02} {u}_{a , b}^{i} {R}_{a , b}^{i} ( {θ}_{1} , {θ}_{2} ) , , \qquad ( 19 )$$

where uⁱ_{a,b′}s are the displacement control variables.

In the case of a Kirchhoff-Love shell analysis of structures composed of multiple NURBS patches, the designer and analyzer 152 may implement additional aspects. For example, the designer and analyzer 152 may enforce linear constraints between displacement control variables at the adjacent NURBS patches to maintain a conforming discretization.

For the connection of two patches, there are two general cases, namely a G¹-continuous connection and a connection with a kink.

Regarding the G¹-continuous connection, for parametric surfaces, G¹-continuity represents that two surfaces joining at a common edge have a common tangent plane at each point along that edge. For NURBS surfaces, this condition is satisfied if the control points across the common edge are collinear, that is,

P_{2,j}²=(1+c)P_{n,j}¹−cP_{n-1,j}¹, (20),

where c is a scalar.

For rotation-free shell analysis, the condition at Equation (2) may be maintained in the deformed state of the structure. For this, designer and analyzer 152 may impose the same co-linearity condition on the displacement control variables and their variations based on the following:

u_{2,j}²=(1+c)u_{n,j}¹−cu_{n-1,j}¹, (21), and

δu_{2,j}²=(1+c)δu_{n,j}¹−cδu_{n-1,j}¹, (22).

Equations (21) and (22) represent a linear constraint that can be fulfilled by the designer and analyzer 152 when performing an analysis at 220. Although the approach leads to the desired results, explicitly using the constraints of Equations (20) and (21) for every control point at the patch interface may not be necessary.

Regarding a connection with a kink, if two parametric surfaces are joined with a kink (i.e., a C⁰ connection with no common tangent plane), the angle between the patches may be maintained in the deformed configuration. Similar to the G¹-continuous case, this may be achieved by coupling the respective control points along a common edge. For each triple of control points P_{2,j}², P_{n,j}¹ and P_{n-1,j}¹, the angle spanned by these control points must remain constant during deformation. The angle may be expressed using the scalar product as follows:

$$α = {cos}^{- 1} ( \frac{( {P}_{n , j}^{1} - {P}_{n - 1 , j}^{1} ) \cdot ( {P}_{2 , j}^{2} - {P}_{n , j}^{1} )}{\vert {P}_{n , j}^{1} - {P}_{n - 1 , j}^{1} \vert \cdot \vert {P}_{2 , j}^{2} - {P}_{n , j}^{1} \vert} ) , , \qquad ( 23 )$$

which does not lead to a linear constraint relationship for the displacement degrees of freedom in the general case. As a result, the angle constraint may not be enforced in a strong sense by a direct coupling of degrees of freedom as in the G¹-continuous case.

In some implementations, the designer and analyzer 152 may handle multi-patch shell geometries by maintaining the above mentioned constraints between the displacement degrees of freedom in an approximate sense, rather than strongly. Moreover, the designer and analyzer 152 may make no distinction between the two situations presented above, i.e., a G¹-continuous connection and a connection with a kink.

In some implementations, complex multi-patch shell structures consisting of modeling structural geometry may be handled by designer and analyzer 152 using NURBS patches that are joined with a C⁰-continuity. In addition, bending strips of fictitious material modeled as surface NURBS patches are placed at patch intersections.

FIG. 3 shows an example of these NURBS patches 310 and 320 bound by a bending strip 305. The triples of control points at the patch interface, which consists of a shared control point and one on each side, are extracted and used as a control net for the bending strip 305. The parametric domain of the bending strip 305 may consist of one quadratic element in the direction transverse to the strip of as many linear elements as necessary to accommodate the control points along the length of the strip. The material may be assumed to have substantially zero mass, substantially zero membrane stiffness, and substantially non-zero bending stiffness only in the direction transverse to the strip. The transverse direction may be obtained using the local basis construction noted above.

The designer and analyzer 152 may be configured to use the following additional term for each bending strip of the structure:

$$δ {W}_{int}^{s} = - {\int }_{A} \frac{{t}^{3}}{12} {\overline{κ}}^{T} {\overline{C}}_{s} δ \overline{κ} d A . \qquad ( 24 )$$

The bending strip 305 constitutive material matrix C̅ₛ may be given by the following equation:

$${\overline{C}}_{s} = [ \begin{matrix}{E}_{s} & 0 & 0 \\ 0 & 0 & 0 \\ 0 & 0 & 0\end{matrix} ] , , \qquad ( 25 )$$

where Eₛ is the directional bending stiffness.

The material constitutive matrix of Equation (25) may ensures that the bending strip 305 adds substantially no extra stiffness to the structure. They only penalize the change in the angle during the deformation between the triples of control points at the patch interface. The stiffness Eₛ may be high enough that the change in angle is within an acceptable tolerance. However, if Eₛ is chosen too high, the global stiffness matrix may become badly conditioned, which may lead to divergence in the computations.

To further illustrate, FIGS. 8A-B show an example of an L-shape cantilever with a point load. In particular FIG. 8A shows the geometry consisting of two rectangular patches meeting at a 90° angle, which corresponds to the connection with a kink, and FIG. 8B shows the deformed configuration for the case when the patches are connected with C⁰-continuity only, e.g., without the bending strip. As can be seen, the C⁰-continuous connection unintentionally acts like a hinge between the patches, and no bending moment is transferred. The situation is rectified by adding a bending strip.

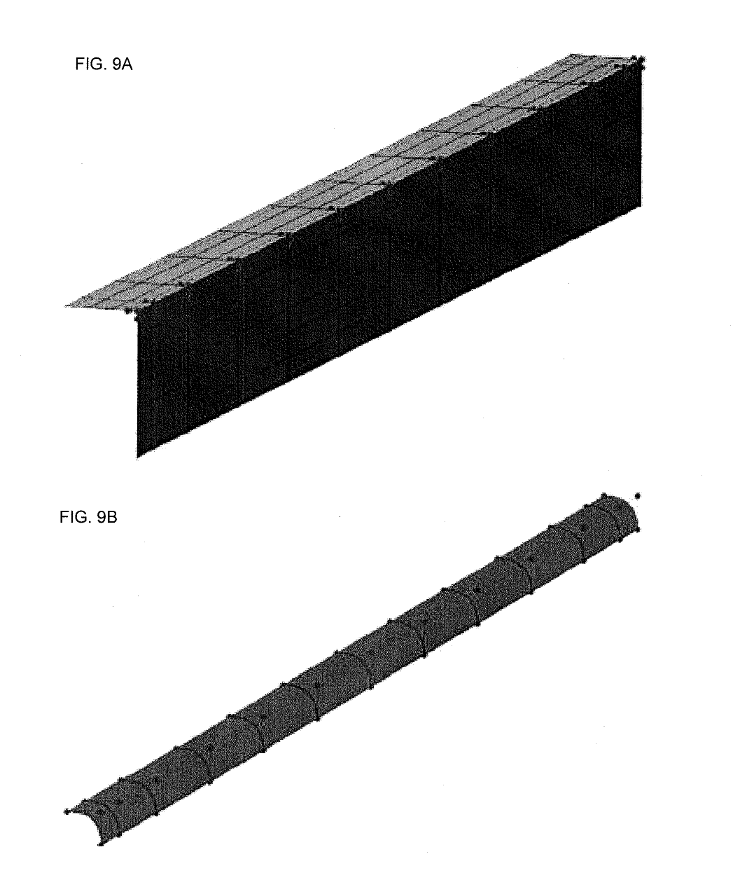

In FIG. 9A, the control points are coupled by the bending strip, while at FIG. 9B the bending strip is built using these control points.

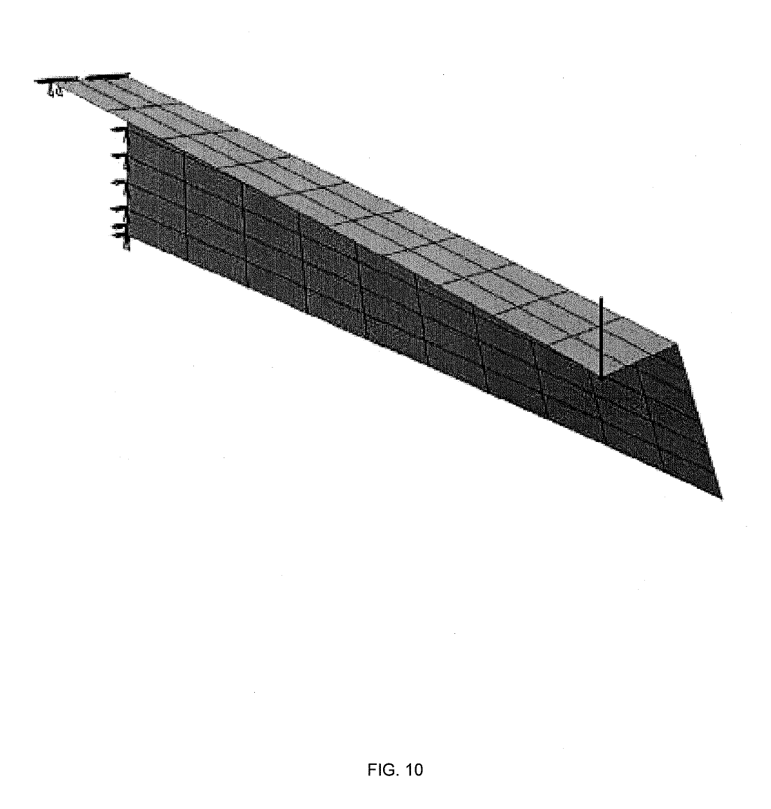

In FIG. 10, the resulting deformation with the bending strip is shown. As can be seen, the angle between the patches remains nearly constant during deformation.

In some implementations, the system 100 may use the same model 154 representing a structure of a blade to design, analyze, simulate, and manufacture the blade. Moreover, this model 154 may be configured in accordance with NURBS and bending strips. This may enable a designer/analyst to work in the same system throughout the process 200.

The subject matter described herein may be embodied in systems, apparatus, methods, and/or articles depending on the desired configuration. For example, the control module may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. In some implementations, the subject matter described herein may be implemented inside a system including at least one of a CAD system, a simulation system, and an analysis system.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
generating a model of an object, wherein the model defines at least a surface of the object, wherein the surface comprises a plurality of patches generated based on a function;
presenting, at a user interface, the surface of the object in accordance with the model;
inserting into the model of the object a bending strip between a first patch on the surface and a second patch on the surface;
performing an analysis of the model including the bending strip, the first patch, and the second patch; and
presenting, at the user interface, a three-dimensional representation of the object including a result of the analysis.

2. The method of claim 1, wherein the bending strip represents a virtual material on the surface of the object.

3. The method of claim 1, wherein the bending strip provides unidirectional bending stiffness.

4. The method of claim 1, wherein the bending strip provides substantially zero membrane stiffness at an interface of the first patch and the second patch.

5. The method of claim 1, wherein the function comprises at least one of a spline, a T-spline, and a non-uniform rational B-spline.

6. The method of claim 1, wherein the bending strip is configured in accordance with at least one of a spline, a T-spline, and a non-uniform rational B-spline.

7. The method of claim 1, wherein the inserting further comprises:
detecting an interface between the first patch and the second patch; and
inserting, based on the detection, the bending strip.

8. The method of claim 1, wherein the object comprises a blade.

9. The method of claim 1, wherein the model represent at least the surface during a design, a simulation, and a manufacture of the object.

10. A system comprising:
at least one processor; and
at least one memory including code which when executed by the at least one processor causes operations comprising:
generating a model of an object, wherein the model defines at least a surface of the object, wherein the surface comprises a plurality of patches generated based on a function;
presenting, at a user interface, the surface of the object in accordance with the model;
inserting into the model of the object a bending strip between a first patch on the surface and a second patch on the surface;
performing an analysis of the model including the bending strip, the first patch, and the second patch; and
presenting, at the user interface, a three-dimensional representation of the object including a result of the analysis.

11. The system of claim 10, wherein the bending strip represents a virtual material on the surface of the object.

12. The system of claim 10, wherein the bending strip provides unidirectional bending stiffness.

13. The system of claim 10, wherein the bending strip provides substantially zero membrane stiffness at an interface of the first patch and the second patch.

14. The system of claim 10, wherein the function comprises at least one of a spline, a T-spline, and a non-uniform rational B-spline.

15. A non-transitory computer-readable medium including code, which when executed by at least one processor causes operations comprising:
generating a model of an object, wherein the model defines at least a surface of the object, wherein the surface comprises a plurality of patches generated based on a function;
presenting, at a user interface, the surface of the object in accordance with the model;
inserting into the model of the object a bending strip between a first patch on the surface and a second patch on the surface;
performing an analysis of the model including the bending strip, the first patch, and the second patch; and
presenting, at the user interface, a three-dimensional representation of the object including a result of the analysis.

16. The non-transitory computer-readable medium of claim 15, wherein the bending strip represents a virtual material on the surface of the object.

17. The non-transitory computer-readable medium of claim 15, wherein the bending strip provides unidirectional bending stiffness.

18. The non-transitory computer-readable medium of claim 15, wherein the bending strip provides substantially zero membrane stiffness at an interface of the first patch and the second patch.

19. The non-transitory computer-readable medium of claim 15, wherein the function comprises at least one of a spline, a T-spline, and a non-uniform rational B-spline.
